(19) United States
(12) Patent Application Publication
(10) Pub. No.: US 2024/0072259 A1
(43) Pub. Date: Feb. 29, 2024

(54) SYSTEM AND METHOD FOR A LOW-RESISTANCE HIGH-LOADING LITHIUM-ION BATTERY CELL

(71) Applicant: GM GLOBAL TECHNOLOGY OPERATIONS LLC, Detroit, MI (US)

(72) Inventors: Michael A. Lelli, Rochester, MI (US); Seung-Woo Chu, Clawson, MI (US); Gayatri V. Dadheech, Bloomfield Hills, MI (US)

(73) Assignee: GM GLOBAL TECHNOLOGY OPERATIONS LLC, Detroit, MI (US)

(21) Appl. No.: 17/894,687

(22) Filed: Aug. 24, 2022

(51) Int. Cl. H01M 4/62; H01M 4/04; H01M 10/0525

(52) U.S. Cl. CPC H01M 4/625; H01M 4/0404; H01M 10/0525; H01M 2004/027

(57) ABSTRACT

A system including a lithium-ion battery cell is disclosed. The lithium-ion battery cell includes a first electrode. The first electrode includes a current collector including a surface and an electrode coating formed from an electrode coating slurry and disposed on the current collector. The electrode coating slurry includes a plurality of flakes of flake graphite. Each of the plurality of flakes includes two parallel planar surfaces and an edge plane defined by the two parallel planar surfaces. The edge planes of the plurality of flakes are statistically facing toward the surface of the current collector. The first electrode further includes a conductive material including a high aspect ratio nano-sized carbon material. The carbon material is configured for providing attractive forces between components of the electrode coating. The lithium-ion battery cell further includes a second electrode, a separator disposed between the first electrode and the second electrode, and an electrolyte.

### INTRODUCTION

The disclosure generally relates to a system and method for a low-resistance high-loading lithium-ion battery cell.

A battery cell may include an anode, a cathode, a separator, an electrolyte, and an enclosure. The battery cell may operate in charging cycles and discharging cycles. In one embodiment, the battery cell may be a prismatic battery cell including a hard outer case, frequently constructed with metal, polymer, or polymeric film. The anode and the cathode may each include multiple components including graphite, active materials and/or a high aspect ratio nano-sized carbon material configured for an electrochemical reaction useful to provide electrical energy from the battery cell.

### SUMMARY

A system including a lithium-ion battery cell is disclosed. The lithium-ion battery cell includes a first electrode. The first electrode includes a current collector including a surface and an electrode coating formed from an electrode coating slurry and disposed on the current collector. The electrode coating slurry includes a plurality of flakes of flake graphite. Each of the plurality of flakes includes two parallel planar surfaces and an edge plane defined by the two parallel planar surfaces. The edge planes of the plurality of flakes are statistically facing toward the surface of the current collector. The first electrode further includes a conductive material including a high aspect ratio nano-sized carbon material. The high aspect ratio nano-sized carbon material is configured for providing attractive forces between components of the electrode coating. The lithium-ion battery cell further includes a second electrode, a separator disposed between the first electrode and the second electrode, and an electrolyte.

In some embodiments, the electrode coating slurry is free from a polymeric binder.

In some embodiments, the electrode coating slurry includes a polymeric binder present in an amount of less than or equal to one unit by weight of the polymeric binder per one hundred units by weight of the electrode coating slurry.

In some embodiments, the edge plane of at least 50% of the plurality of flakes defines an angle relative to the surface of the current collector of from 45 degrees to 90 degrees.

In some embodiments, the edge plane of at least 75% of the plurality of flakes defines an angle relative to the surface of the current collector of from 45 degrees to 90 degrees.

In some embodiments, the edge plane of at least 50% of the plurality of flakes defines an angle relative to the surface of the current collector of from 60 degrees to 90 degrees.

In some embodiments, the edge plane of at least 75% of the plurality of flakes defines an angle relative to the surface of the current collector of from 60 degrees to 90 degrees.

In some embodiments, the first electrode is an anode.

In some embodiments, the first electrode is a cathode.

In some embodiments, the first electrode is an anode, and the electrode coating slurry further includes a blended silicon anode active material with multiscale porosity.

According to one alternative embodiment, a system including a low-resistance high-loading lithium-ion battery cell is provided. The lithium-ion battery cell includes an anode and a cathode. The cathode includes a cathode current collector including a first surface and a cathode coating formed from a cathode coating slurry and disposed on the cathode. The cathode coating slurry includes a first plurality of flakes of flake graphite. Each of the first plurality of flakes including two parallel planar surfaces and an edge plane defined by the two parallel planar surfaces. The edge planes of the first plurality of flakes are statistically facing toward the first surface. The lithium-ion battery cell further includes a separator disposed between the cathode and the anode and an electrolyte.

In some embodiments, the anode includes an anode current collector including a second surface and an anode coating formed from an anode coating slurry and disposed on the anode. The anode coating slurry includes a second plurality of flakes of the flake graphite. Each flake includes the two parallel planar surfaces and the edge plane defined by the two parallel planar surfaces. The edge planes of the second plurality of flakes are statistically facing toward the second surface.

In some embodiments, the edge plane of at least 75% of the first plurality of flakes defines an angle relative to the surface of the cathode current collector of from 60 degrees to 90 degrees. The edge plane of at least 75% of the second plurality of flakes defines an angle relative to the surface of the anode current collector of from 60 degrees to 90 degrees.

In some embodiments, the edge plane of at least 50% of the first plurality of flakes defines an angle relative to the surface of the cathode current collector of from 45 degrees to 90 degrees.

In some embodiments, the edge plane of at least 75% of the first plurality of flakes defines an angle relative to the surface of the cathode current collector of from 45 degrees to 90 degrees.

In some embodiments, the edge plane of at least 50% of the first plurality of flakes defines an angle relative to the surface of the current collector of from 60 degrees to 90 degrees.

According to one alternative embodiment, a method for forming an electrode for a low-resistance high-loading lithium-ion battery cell is provided. The method includes creating an electrode coating slurry including a plurality of flakes of flake graphite. Each of the plurality of flakes includes two parallel planar surfaces and an edge plane defined by the two parallel planar surfaces. The electrode slurry further includes a conductive material including a high aspect ratio nano-sized carbon material. The high aspect ratio nano-sized carbon material is configured for providing attractive forces within the electrode coating slurry. The method further includes depositing the electrode coating slurry upon a current collector including a surface and drying the electrode coating slurry upon the current collector in a presence of a magnetic field to statistically orient the edge planes of the plurality of flakes toward the surface and thereby form the electrode.

In some embodiments, the method further includes installing the electrode in the low-resistance high-loading lithium-ion battery cell and utilizing the low-resistance high-loading lithium-ion battery cell to provide electrical energy.

In some embodiments, drying the electrode coating slurry orients at least 50% of the plurality of flakes such that each edge plane of the at least 50% of the plurality of flakes defines an angle relative to the surface of the current collector of from 45 degrees to 90 degrees.

In some embodiments, drying the electrode coating slurry orients at least 60% of the plurality of flakes such that each edge plane of the at least 60% of the plurality of flakes defines an angle relative to the surface of the current collector of from 50 degrees to 90 degrees.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary system including a low-resistance high-loading lithium-ion battery cell in accordance with the present disclosure;

FIG. 2 schematically illustrates in magnified scale an anode current collector and an anode coating of the system of FIG. 1, in accordance with the present disclosure;

FIG. 3 schematically illustrates in magnified scale a cathode current collector and a cathode coating of the system of FIG. 1, in accordance with the present disclosure;

FIG. 4 schematically illustrates an exemplary device embodied as a vehicle including an energy storage device including at least one low-resistance high-loading lithium-ion battery cell of FIG. 1, in accordance with the present disclosure; and

FIG. 5 is a flowchart illustrating an exemplary method for forming an electrode, in accordance with the present disclosure.

### DETAILED DESCRIPTION

A system and a method for forming an electrode for a low-resistance high-loading lithium-ion battery cell are provided. The low-resistance high-loading lithium-ion battery cell includes a pair of electrodes, i.e., an anode and a cathode. Electrodes may each include an active material, a conductive material, a polymeric binder, and a current collector. The disclosed low-resistance high-loading lithium-ion battery cell may include flake-shaped graphite as an active material or as a conductive material. The anode and the cathode may each include additional active materials configured for an electrochemical reaction useful to provide electrical energy from the low-resistance high-loading lithium-ion battery cell and high aspect ratio nano-sized carbon material as conductive material as well as a partial or whole replacement of polymeric binder.

An electrode includes a current collector, a conductive piece of material, and an electrode coating upon the current collector. The disclosed system and method include an electrode coating including flake graphite including a plurality of flakes which is statistically biased to being aligned toward the current collector of the electrode. The flakes statistically biased to being aligned toward the current collector may be described as the edge plane of 50% of the flakes present facing electrode current collector. Described another way, the flakes statistically biased to being aligned toward the current collector may be described as a majority of the flakes including an edge plane defining an angle relative to a surface of the respective current collector of from 45 degrees to 90 degrees. Flake graphite or flaky graphite is a planar piece of material typically with a first planar side surface, a second planar side surface parallel to the first planar side surface, and thin edges around a perimeter of the flake. The edge plane of the flake may be described as a side view of the flake looking directly at a thin edge around the perimeter of the flake. Flake graphite facing a current collector includes a plurality of flakes where the edge plane makes an angle relative to the surface of the current collector between 45 degrees and 90 degrees. Flake graphite with an edge plane ideally facing the current collector would include an edge plane perpendicular to or making a 90-degree angle with the current collector.

Electrode coatings may utilize a polymeric binder to provide structural rigidity and cohesion to the electrode. Polymeric binders may act as an ionic barrier, reducing efficiency of an electrode. High aspect ratio nano-sized carbon material has a relatively large specific area and tends to adhere to other electrode components due to van der Waals forces between materials. By utilizing high aspect ratio nano-sized carbon material in the electrode, the use of polymeric binders in the electrode may be made less important. The disclosed system and method enable an electrode coating including a reduced amount of polymeric binder or no polymeric binder. This configuration enables a high-loading electrode design without compromising cell level performance by off-setting power/charging performance of a high-loading electrode. Reducing or eliminating use of a polymeric binder in an electrode may improve battery power and battery charging performance.

The disclosed system and method enable high silicon content in an anode electrode. Elimination of a polymeric binder aids in decreasing of lithium-ion diffusion resistance on the surface of silicon active material while maintaining an electrical conductive path regardless of volume change due to high-aspect-ratio nano-size carbon fiber(s) i.e. Single-wall carbon nanotubes (SWCNT) or multi-wall carbon nanotubes (MWCNT). Additionally, this configuration reduces diffusion paths for lithium-ion intercalation into graphite by controlling alignment of flake graphite edge plane.

The disclosed method using flakes facing toward the current collector in an electrode may be utilized in an anode of a battery cell, in a cathode of a battery cell, or in both an anode and a cathode of a battery cell. An anode electrode may include a current collector, an anode active material, and a conductive material with no polymeric binder. In one embodiment, the conductive material may include high aspect ratio nano-sized carbon material and may have an aspect ratio higher than 50, determined as material length divided by material diameter. The anode may utilize flake-shape graphite material as an anode active material, with the anode electrode coating including flake-shape graphite material with a minimum concentration of 5 parts flake graphite per 100 parts of the anode coating, with a minimum of 50% of the flake-shaped graphite material's edge planes facing current collector of the assembly.

A cathode electrode may include a current collector, a cathode active material, and a conductive material. The cathode electrode may or may not include a polymeric binder. In one embodiment, the conductive material may include high aspect ratio nano-sized carbon material such as high-aspect-ratio nano-size carbon fiber(s) i.e. SWCNT or MWCNT. The conductive material may have an aspect ratio higher than 30, higher than 50, or higher than 70, determined as material length divided by material diameter. The cathode may further utilize flake-shape graphite material as a conductive material, with the anode electrode coating including flake-shape graphite material with a minimum concentration of 0.5 parts flake graphite per 100 parts of the cathode coating, with a minimum of 50% of the flake-shaped graphite material's edge planes facing current collector of the assembly. Graphite works as a heat dissipation pathway, so graphite aligned toward the current collector of the cathode may improve performance of the battery cell by reducing the temperature of the cathode electrode. This lower temperature may help in minimizing side reactions between cathode and an electrolyte.

An electrode including an electrode coating may be created by creating a slurry or a viscous liquid composition including the components to be deposited within the electrode coating, depositing or disposing the slurry upon a current collector, and drying or curing the slurry into a solid coating upon the current collector. In order to create an electrode coating wherein at least 50% of the flake-shaped graph material's edge planes face the current collector, one may create a high intensity magnetic field on the wet slurry deposited upon the current collector during a solvent drying process. The graphite exhibits ferromagnetic properties and tend to align to a magnetic field. One may orient the magnetic field such that the flakes orient or face in the desired orientation toward the current collector.

In one embodiment, an anode may include high-silicon-content blended anode active material with multiscale porosity or an anode active material with silicon blended at high content. The silicon may be mixed with high aspect ratio carbons, flake graphite statistically facing toward the current collector, and surface treated carbon additives for high electrical and ionic conductivity. This embodiment may enable relatively fast charging cycles.

The disclosed system and method may include a lithium-ion cell including at least one single cathode electrode assembly, at least one single anode electrode assembly, and at least one separator enclosed in pouch or metallic can with an electrolyte, where at least one of electrode assembly, at least one of the anode electrode assembly and the cathode electrode assembly, includes an electrode coating including an active material, conductive material, current collector, and without a polymeric binder. The electrode coating includes flake shape graphite as an active material or as a conductive material, where in the edge plane of 50% of graphite material is facing toward the electrode current collector.

An electrode coating including flake graphite statistically facing toward a respective current collector may include at least 50% of the flakes having an edge plane making an angle relative to a surface of the current collector between 45 degrees and 90 degrees. An electrode coating including flake graphite statistically facing toward a respective current collector may include at least 60% of the flakes having an edge plane making an angle relative to a surface of the current collector between 45 degrees and 90 degrees. An electrode coating including flake graphite statistically facing toward a respective current collector may include at least 75% of the flakes having an edge plane making an angle relative to a surface of the current collector between 45 degrees and 90 degrees.

An electrode coating including flake graphite statistically facing toward a respective current collector may include at least 50% of the flakes having an edge plane making an angle relative to a surface of the current collector between 50 degrees and 90 degrees. An electrode coating including flake graphite statistically facing toward a respective current collector may include at least 50% of the flakes having an edge plane making an angle relative to a surface of the current collector between 60 degrees and 90 degrees. An electrode coating including flake graphite statistically facing toward a respective current collector may include at least 75% of the flakes having an edge plane making an angle relative to a surface of the current collector between 60 degrees and 90 degrees.

A system includes a lithium-ion battery cell. The lithium-ion battery cell includes a first electrode including a current collector including a surface and an electrode coating formed from an electrode coating slurry and disposed on the current collector. The electrode coating slurry includes a plurality of flakes of flake graphite. Each of the plurality of flakes includes two parallel planar surfaces and an edge plane defined by the two parallel planar surfaces. The edge planes of the plurality of flakes are statistically facing toward the surface of the current collector. The electrode slurry further includes a conductive material including a high aspect ratio nano-sized carbon material. The high aspect ratio nano-sized carbon material is configured for providing attractive forces between components of the electrode coating. The lithium-ion battery cell further includes a second electrode, a separator disposed between the first electrode and the second electrode, and an electrolyte.

The electrode coating slurry may be free from a polymeric binder.

The electrode coating slurry may include a polymeric binder present in an amount of less than or equal to one unit by weight of the polymeric binder per one hundred units by weight of the electrode coating slurry.

The edge plane of at least 50% of the plurality of flakes may define an angle relative to the surface of the current collector of from 45 degrees to 90 degrees.

The edge plane of at least 75% of the plurality of flakes may define an angle relative to the surface of the current collector of from 45 degrees to 90 degrees.

The edge plane of at least 50% of the plurality of flakes may define an angle relative to the surface of the current collector of from 60 degrees to 90 degrees.

The edge plane of at least 75% of the plurality of flakes may define an angle relative to the surface of the current collector of from 60 degrees to 90 degrees.

The first electrode may be an anode.

The first electrode may be a cathode.

The first electrode may be an anode, and the electrode coating slurry may further include a blended silicon anode active material with multiscale porosity.

An alternative system includes a low-resistance high-loading lithium-ion battery cell. The lithium-ion battery cell includes an anode and a cathode including a cathode current collector including a first surface. The cathode further includes a cathode coating formed from a cathode coating slurry and disposed on the cathode. The cathode coating slurry includes a first plurality of flakes of flake graphite. Each of the first plurality of flakes including two parallel planar surfaces and an edge plane defined by the two parallel planar surfaces. The edge planes of the first plurality of flakes are statistically facing toward the first surface. The lithium-ion battery further includes a separator disposed between the cathode and the anode and an electrolyte.

The anode may include an anode current collector including a second surface. The anode may further include an anode coating formed from an anode coating slurry and disposed on the anode. The anode coating slurry includes a second plurality of flakes of the flake graphite each including the two parallel planar surfaces and the edge plane defined by the two parallel planar surfaces. The edge planes of the second plurality of flakes are statistically facing toward the second surface.

The edge plane of at least 75% of the first plurality of flakes may define an angle relative to the surface of the cathode current collector of from 60 degrees to 90 degrees. The edge plane of at least 75% of the second plurality of flakes may define an angle relative to the surface of the anode current collector of from 60 degrees to 90 degrees.

The edge plane of at least 50% of the first plurality of flakes may define an angle relative to the first surface of the cathode current collector of from 45 degrees to 90 degrees.

The edge plane of at least 75% of the first plurality of flakes may define an angle relative to the first surface of the cathode current collector of from 45 degrees to 90 degrees.

The edge plane of at least 50% of the first plurality of flakes may define an angle relative to the first surface of the cathode current collector of from 60 degrees to 90 degrees.

A method for forming an electrode for a low-resistance high-loading lithium-ion battery cell is provided. The method includes creating an electrode coating slurry including a plurality of flakes of flake graphite. Each of the plurality of flakes includes two parallel planar surfaces and an edge plane defined by the two parallel planar surfaces. The electrode coating slurry further includes a conductive material including a high aspect ratio nano-sized carbon material. The high aspect ratio nano-sized carbon material is configured for providing attractive forces within the electrode coating slurry. The method further includes depositing the electrode coating slurry upon a current collector including a surface and drying the electrode coating slurry upon the current collector in a presence of a magnetic field to statistically orient the edge planes of the plurality of flakes toward the surface and thereby form the electrode.

The method may include installing the electrode in the low-resistance high-loading lithium-ion battery cell and utilizing the low-resistance high-loading lithium-ion battery cell to provide electrical energy.

Drying the electrode coating slurry may orient at least 50% of the plurality of flakes such that each edge plane of the at least 50% of the plurality of flakes defines an angle relative to the surface of the current collector of from 45 degrees to 90 degrees.

Drying the electrode coating slurry may orient at least 60% of the plurality of flakes such that each edge plane of the at least 60% of the plurality of flakes defines an angle relative to the surface of the current collector of from 50 degrees to 90 degrees.

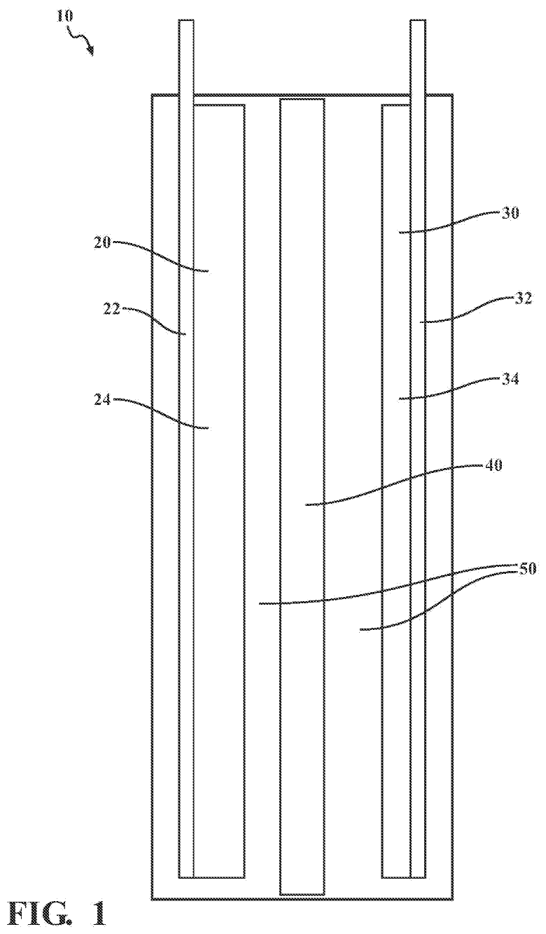

Referring now to the drawings, wherein like reference numbers refer to like features throughout the several views, FIG. 1 schematically illustrates an exemplary system 10 including for a low-resistance high-loading lithium-ion battery cell. The system 10 operates as a battery cell and is illustrated including an anode current collector 22, an anode coating 20, a cathode current collector 32, a cathode coating 30, a separator 40, and an electrolyte 50. The anode coating 20 and the anode current collector 22 may be collectively described as an anode 25. The cathode coating 30 and the cathode current collector 32 may be collectively described as a cathode 35. At least one of the anode coating 20 and the cathode coating 30 include flake graphite statistically facing toward the respective anode current collector 22 or the respective cathode current collector 32.

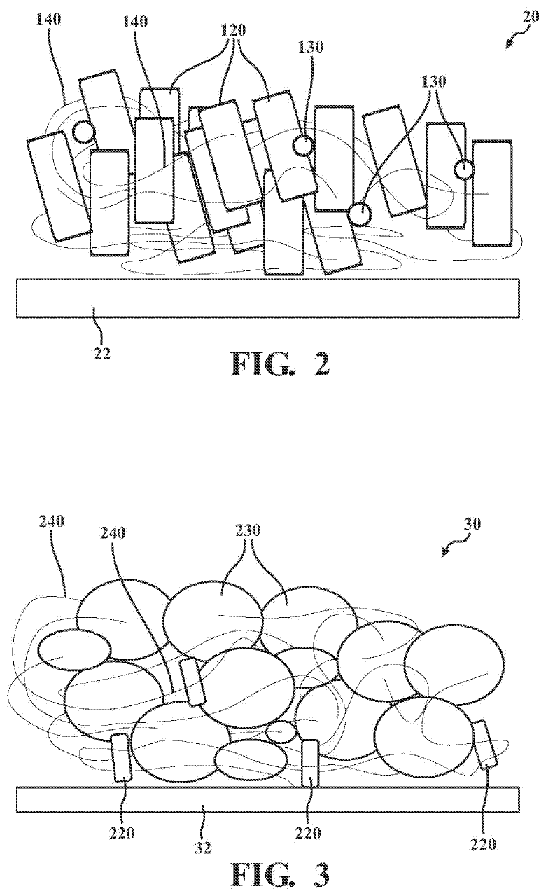

FIG. 2 schematically illustrates in magnified scale the anode current collector 22 and the anode coating 20 of FIG. 1. The anode current collector 22 is illustrated including a surface 27 and may be a conductive material such as copper. The surface 27 may be flat, curved, or include another shape. Flakes 120 are illustrated as rectangular particles for purposes of illustration. Flakes 120 may include irregularly shaped and sized materials, and the rectangular particles of the illustration are being used to represent angles of edge planes of the flakes 120 to a surface of the anode current collector 22. The flakes 120 may be utilized as active materials within the anode coating 20. Additional anode active materials 130 are illustrated. Additionally, conductive materials 140 are illustrated. In one embodiment, the conductive materials 140 may include high aspect ratio nano-sized carbon material. In another embodiment, the conductive materials 140 may include CNTs.

The relative sizes of the anode current collector 22, the flakes 120, the anode active materials 130, and the conductive materials 140 are represented for purpose of illustration only. The components of the anode coating 20 may individually be microscopic, and the anode current collector 22 may be a millimeter thick or greater.

FIG. 3 schematically illustrates in magnified scale the cathode current collector 32 and the cathode coating 30 of FIG. 1. The cathode current collector 32 is illustrated including a surface 37 and may be a conductive material such as copper. Flakes 220 are illustrated as rectangular particles for purposes of illustration. Flakes 220 may include irregularly shaped and sized materials, and the rectangular particles of the illustration are being used to represent angles of edge planes of the flakes 220 to a surface of the cathode current collector 32. The flakes 220 may be utilized as conductive materials within the cathode coating 30. Additionally, cathode active materials 230 are illustrated. Additional conductive materials 240 are illustrated. In one embodiment, the conductive materials 240 may include high aspect ratio nano-sized carbon material. In another embodiment, the conductive materials 240 may include CNTs.

The relative sizes of the cathode current collector 32, the flakes 220, the cathode active materials 230, and the conductive materials 240 are represented for purpose of illustration only. The components of the cathode coating 30 may individually be microscopic, and the cathode current collector 32 may be a millimeter thick or greater.

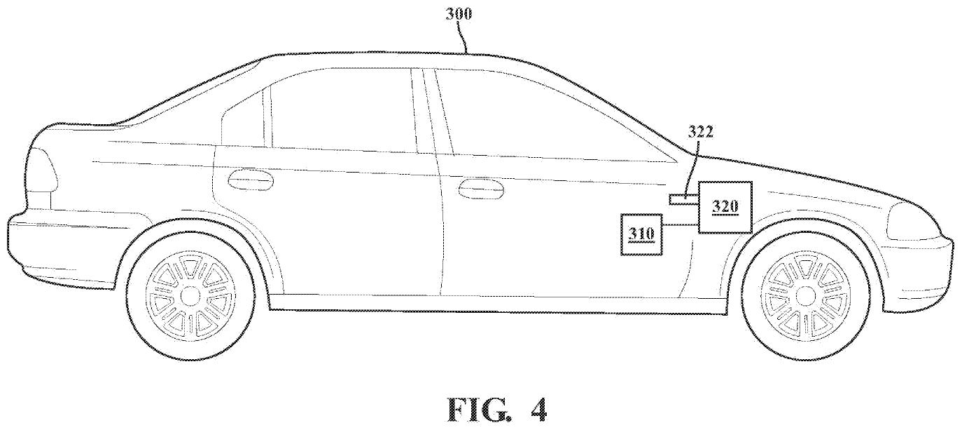

FIG. 4 schematically illustrates an exemplary device 300 embodied as a vehicle including an energy storage device 310 including at least one system 10 of FIG. 1. The energy storage device 310 stores chemical energy and provides electrical energy for use by the device 300. The energy storage device 310 may include a plurality of battery cells. The energy storage device 310 provides electrical energy to an electric machine 320 which may utilize the electrical energy to provide an output torque to an output component 322 embodied as an output shaft.

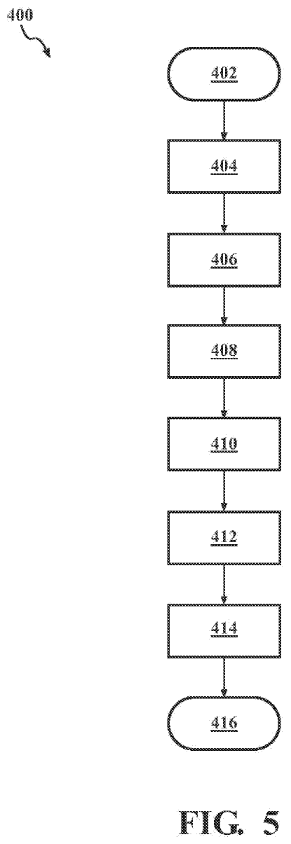

FIG. 5 is a flowchart illustrating an exemplary method 400 for creating and using a low-resistance high-loading lithium-ion battery cell. The method 400 may utilize the physical components illustrated in system 10 of FIG. 1 and the corresponding electrode coatings of FIGS. 2 and 3, although the method 400 may utilize alternative physical embodiments to the illustrated system 10. The method 400 starts at a step 402. At a step 404, an anode coating slurry is created. At a step 406, the anode coating slurry is deposited upon an anode current collector 22 as an anode coating 20 in a presence of a first magnetic field configured for causing flakes in the anode coating slurry to statistically face toward a surface of the anode current collector 22. At step 406, the magnetic field may be maintained while the anode coating slurry dries or is cured upon the anode current collector 22. At step 408, a cathode coating slurry is created. At a step 410, the cathode coating slurry is deposited upon a cathode current collector 32 as a cathode coating 30 in a presence of a second magnetic field configured for causing graphite flakes in the cathode coating slurry to statistically face toward a surface of the cathode current collector 32. At step 410, the magnetic field may be maintained while the cathode coating slurry dries or is cured upon the cathode current collector 32. The steps 404 and 406 may be performed simultaneously with the steps 408 and 410. At a step 412, the anode current collector 22 with the anode coating 20 and the cathode current collector 32 with the cathode coating 30 are utilized to create a battery cell. At a step 414, the battery cell is utilized to provide electrical energy to the device 300. At a step 416, the method 400 ends. The method 400 is provided as one exemplary method to create and utilize a low-resistance high-loading lithium-ion battery cell. A number of additional and/or alternative method steps are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A system comprising:
a lithium-ion battery cell including:
a first electrode including:
a current collector including a surface; and
an electrode coating formed from an electrode coating slurry and disposed on the current collector, wherein the electrode coating slurry includes:
a plurality of flakes of flake graphite, each of the plurality of flakes including two parallel planar surfaces and an edge plane defined by the two parallel planar surfaces, wherein the edge planes of the plurality of flakes are statistically facing toward the surface of the current collector; and
a conductive material including a high aspect ratio nano-sized carbon material, wherein the high aspect ratio nano-sized carbon material is configured for providing attractive forces between components of the electrode coating;
a second electrode;
a separator disposed between the first electrode and the second electrode; and
an electrolyte.

2. The system of claim 1, wherein the electrode coating slurry is free from a polymeric binder.

3. The system of claim 1, wherein the electrode coating slurry includes a polymeric binder present in an amount of less than or equal to one unit by weight of the polymeric binder per one hundred units by weight of the electrode coating slurry.

4. The system of claim 1, wherein the edge plane of at least 50% of the plurality of flakes defines an angle relative to the surface of the current collector of from 45 degrees to 90 degrees.

5. The system of claim 1, wherein the edge plane of at least 75% of the plurality of flakes defines an angle relative to the surface of the current collector of from 45 degrees to 90 degrees.

6. The system of claim 1, wherein the edge plane of at least 50% of the plurality of flakes defines an angle relative to the surface of the current collector of from 60 degrees to 90 degrees.

7. The system of claim 1, wherein the edge plane of at least 75% of the plurality of flakes defines an angle relative to the surface of the current collector of from 60 degrees to 90 degrees.

8. The system of claim 1, wherein the first electrode is an anode.

9. The system of claim 1, wherein the first electrode is a cathode.

10. The system of claim 1, wherein the first electrode is an anode; and
wherein the electrode coating slurry further includes a blended silicon anode active material with multiscale porosity.

11. A system comprising:
a low-resistance high-loading lithium-ion battery cell including:
an anode;
a cathode including;
a cathode current collector including a first surface; and
a cathode coating formed from a cathode coating slurry and disposed on the cathode, wherein the cathode coating slurry includes a first plurality of flakes of flake graphite, each of the first plurality of flakes including two parallel planar surfaces and an edge plane defined by the two parallel planar surfaces, wherein the edge planes of the first plurality of flakes are statistically facing toward the first surface;
a separator disposed between the cathode and the anode; and
an electrolyte.

12. The system of claim 11, wherein the anode includes:
an anode current collector including a second surface; and
an anode coating formed from an anode coating slurry and disposed on the anode, wherein the anode coating slurry includes a second plurality of flakes of the flake graphite each including the two parallel planar surfaces and the edge plane defined by the two parallel planar surfaces, wherein the edge planes of the second plurality of flakes are statistically facing toward the second surface.

13. The system of claim 12, wherein the edge plane of at least 75% of the first plurality of flakes defines an angle relative to the surface of the cathode current collector of from 60 degrees to 90 degrees; and
wherein the edge plane of at least 75% of the second plurality of flakes defines an angle relative to the surface of the anode current collector of from 60 degrees to 90 degrees.

14. The system of claim 11, wherein the edge plane of at least 50% of the first plurality of flakes defines an angle relative to the first surface of the cathode current collector of from 45 degrees to 90 degrees.

15. The system of claim 11, wherein the edge plane of at least 75% of the first plurality of flakes defines an angle relative to the first surface of the cathode current collector of from 45 degrees to 90 degrees.

16. The system of claim 11, wherein the edge plane of at least 50% of the first plurality of flakes defines an angle relative to the first surface of the cathode current collector of from 60 degrees to 90 degrees.

17. A method for forming an electrode for a low-resistance high-loading lithium-ion battery cell, the method including:
creating an electrode coating slurry including:
a plurality of flakes of flake graphite, each of the plurality of flakes including two parallel planar surfaces and an edge plane defined by the two parallel planar surfaces; and
a conductive material including a high aspect ratio nano-sized carbon material, wherein the high aspect ratio nano-sized carbon material is configured for providing attractive forces within the electrode coating slurry;
depositing the electrode coating slurry upon a current collector including a surface; and
drying the electrode coating slurry upon the current collector in a presence of a magnetic field to statistically orient the edge planes of the plurality of flakes toward the surface and thereby form the electrode.

18. The method of claim 17, further comprising:
installing the electrode in the low-resistance high-loading lithium-ion battery cell; and
utilizing the low-resistance high-loading lithium-ion battery cell to provide electrical energy.

19. The method of claim 17, wherein drying the electrode coating slurry orients at least 50% of the plurality of flakes such that each edge plane of the at least 50% of the plurality of flakes defines an angle relative to the surface of the current collector of from 45 degrees to 90 degrees.

20. The method of claim 17, wherein drying the electrode coating slurry orients at least 60% of the plurality of flakes such that each edge plane of the at least 60% of the plurality of flakes defines an angle relative to the surface of the current collector of from 50 degrees to 90 degrees.
